(19) United States
(12) Patent Application Publication
(10) Pub. No.: US 2009/0235610 A1
(43) Pub. Date: Sep. 24, 2009

(54) Grid structure

(76) Inventor: Josef Krismer, Innsbruck-Rum (AT)

Correspondence Address: WENDEROTH, LIND & PONACK, L.L.P., 1030 15th Street, N.W.,, Suite 400 East, Washington, DC, 20005-1503, US

(21) Appl. No.: 12/385,499

(22) Filed: Apr. 9, 2009

Related U.S. Application Data
(63) Continuation of application No. PCT/AT2007/000229, filed on May 11, 2007.

(30) Foreign Application Priority Data
Oct. 18, 2006 (AT) A1737/2006
Oct. 24, 2006 (AT) A1791/2006

(51) Int. Cl. E04C 2/42; E04C 5/01; B32B 15/01

(52) U.S. Cl. 52/663; 428/615

(57) ABSTRACT

A grid structure is, in particular, to be used in a reinforcement grid or ground consolidation grid. The grid structure includes a plurality of mutually juxtaposed wire webs formed from wires bent in a zigzag shape, and a plurality of bars which in particular extend in mutually parallel relationship. The wires of the wire webs embrace the bars in the form of substantially closed loops. For fastening to the wire webs, the bars are clamped in the loops of the wire webs by the bars being arranged twisted or tilted relative to the planes of the openings of the loops.

The invention relates to a grid structure, in particular of a reinforcement grid or ground consolidation grid, comprising a plurality of mutually juxtaposed wire webs formed from wires bent in a zigzag shape, and a plurality of bars which in particular extend in mutually parallel relationship, wherein the wires of the wire webs embrace the bars in the form of substantially closed loops.

A grid structure of the general kind set forth is known for example from GB 191501422. In that structure the bars passed through the loops of the wire webs are substantially perpendicular to the planes formed by the zigzag-shaped wire webs. It is admittedly stated in the specification that that structure holds together of its own accord, that is to say already prior to the introduction of filling material. Practice has shown however that arranging bars in substantially closed loops admittedly ensures a certain initial stability, but the loops, due to the movement of the grid structure, relatively quickly expand again so that the bars are no longer sufficiently firmly held in the loops of the zigzag-shaped wire webs.

Practice has further shown that additional fixing, for example by welding or by mounting holding clamps or the like, on the one hand in manufacture signifies additional complication and thus additional costs, while on the other hand those supplementary connecting measures mean that the material of the bars and wire webs can be weakened by heating in the welding operation. Furthermore, those additional fixing measures adversely affect the corrosion protection usually applied to the wires and bars prior to manufacture of the grid, or destroy such protection again.

It is therefore an object of the invention to improve grid structures of the general kind set forth in such a way that a grid structure which is stable in itself is afforded without additional connecting measures.

That is achieved in that for fastening to the wire webs the bars are clamped in the loops of the wire webs by the bars for clamping in the loops of the wire webs being arranged twisted or tilted at least in one direction in relation to the loops.

By virtue of the provision of substantially closed loops, it is possible for the connection between wire webs and bars to be implemented exclusively by clamping. It is possible to dispense with welding or other additional connecting of the bars to the wire webs, by virtue of the force-locking connection which is achieved in that way. Clamping the bars in the loops of the wire webs is achieved by twisting or tilting the bars relative to the planes of the openings of the loops. That prevents the effect known in the state of the art, that the clamping connections can become loose again, by virtue of an increase in the width of the opening of the loops. The grid structure obtained in that way is held together solely by virtue of the clamping action of the wire webs and the bars.

The substantially closed configuration of the loops can be achieved by various measures. Thus it can be provided for example that each two limbs of the wires cross in a crossing region to produce one—preferably all—loops, wherein the smallest spacing of the limbs of the wires relative to each other in the crossing region is less than three times the wire thickness and in particular less than the wire thickness. Additionally or instead thereof however it is also possible to produce a substantially closed loop by the wire of the wire webs being rotated spiral-like a plurality of times about a notional center of the loop. That is achieved if the wire of the wire web is wound through more than 360° about that center to produce the substantially closed loop. This variant also provides that the individual turns of the spiral, which are formed by the wire, bear as closely and snugly as possible against each other.

It can be provided that the fastening of the bars in the loops of the wire webs is based on additional contact of two adjacent loops against each other. In that respect it is immaterial whether for other reasons connecting clamps or the like are additionally mounted at the connecting locations between wires and bars, as long as the structure remains stable in itself by virtue of the clamping action even after removal of those additional connecting elements. Besides the clamping effect, it is optionally also possible to use mutual contact and thus mutual support against each other of two adjacent loops, for further enhancing the stability of the structure.

While clamping of the bars in the loops of the wire webs is already possible by twisting or tilting in one direction, preferred embodiments provide that the bars for clamping in the loops of the wire webs are arranged twisted or tilted at least in two directions with respect to the loops. A particularly strong clamping action is afforded by the double twisting or tilting. Such grid structures can be particularly easily manufactured when the area of an inner opening of a loop is so large that the bar, in relation to its arrangement substantially perpendicularly to a plane of the opening of the loop, is substantially freely movable in the direction of the longitudinal extent of the bar.

The grid structure can be used both for concrete reinforcement and also as a ground consolidation grid.

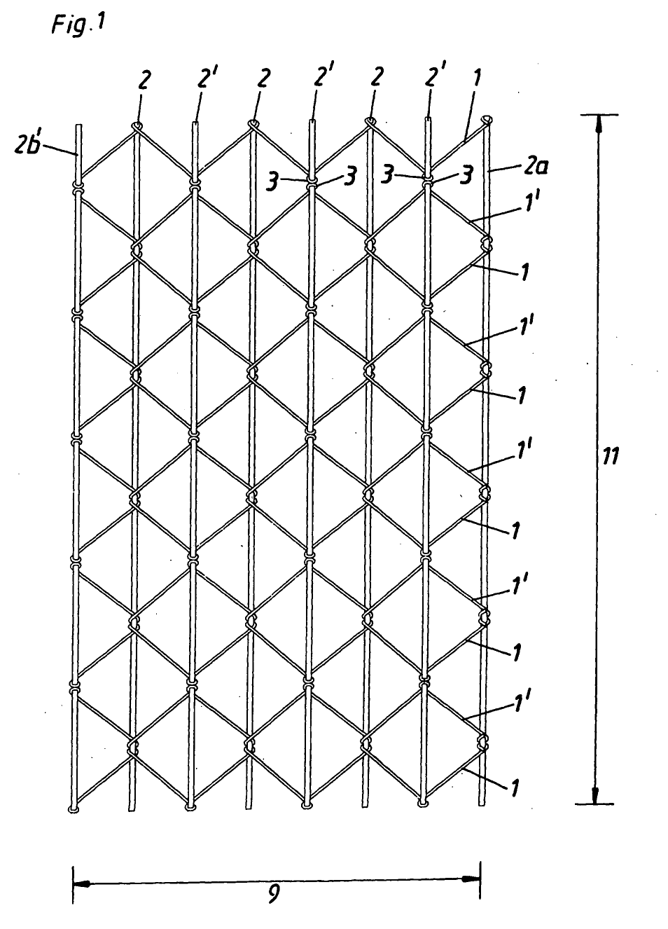

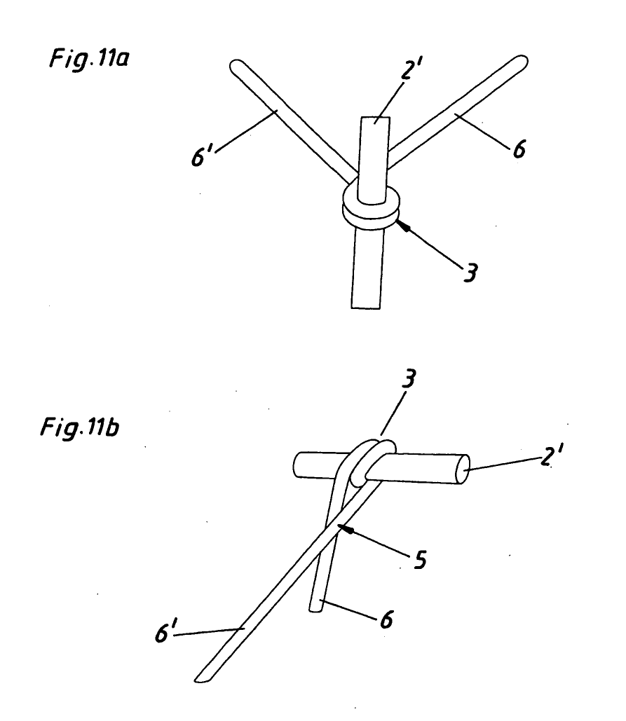

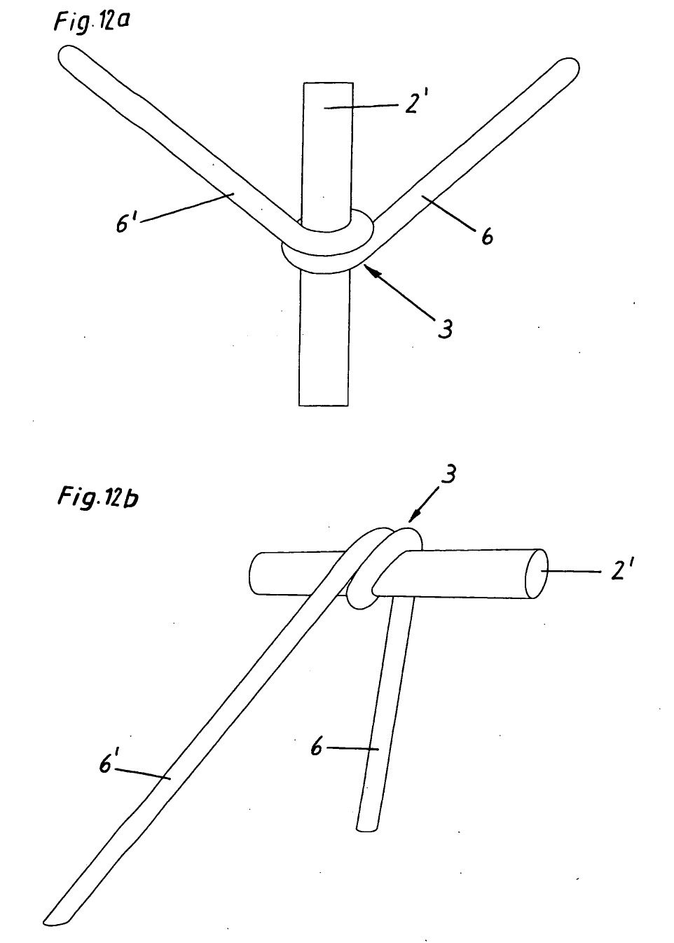

FIGS. 1 through 9c show various views of an embodiment according to the invention of a grid structure. FIGS. 10 and 11 show an alternative according to the invention. In the drawings:

FIG. 1 shows a plan view of the first embodiment,

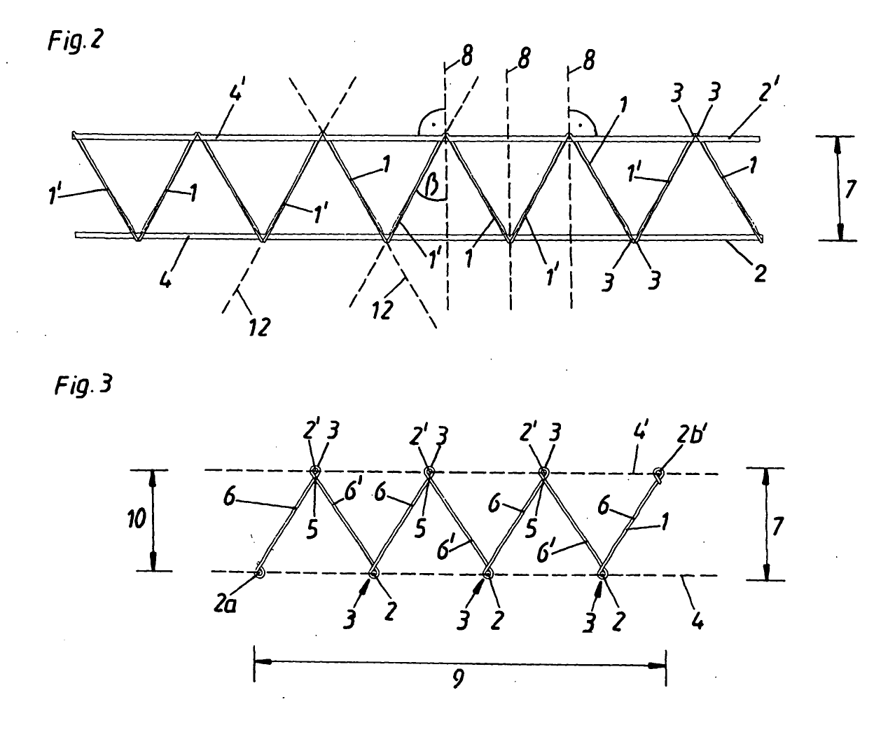

FIG. 2 shows a side view of this embodiment,

FIG. 3 shows a sectional view along a wire web of this embodiment,

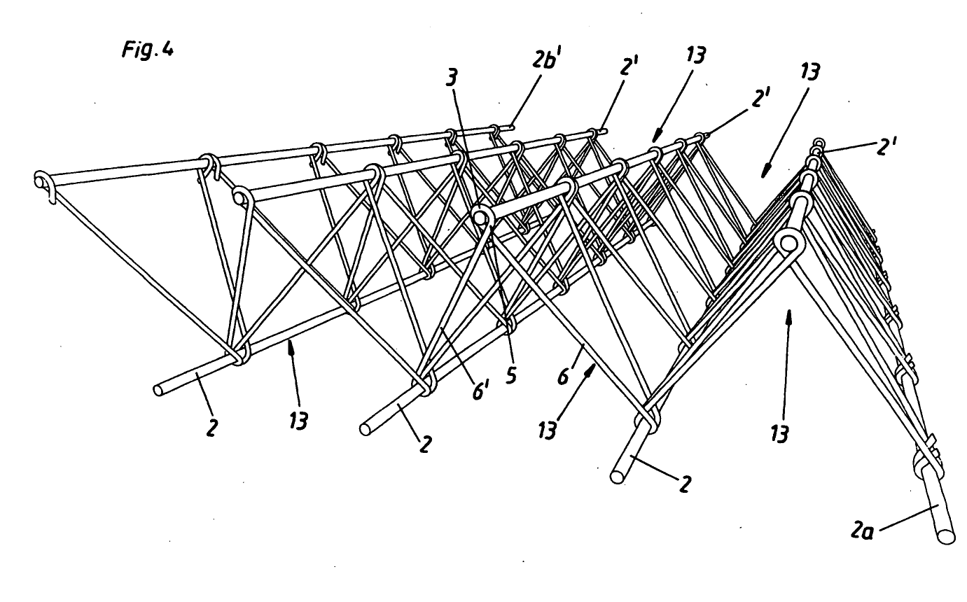

FIG. 4 shows a perspective view of this embodiment,

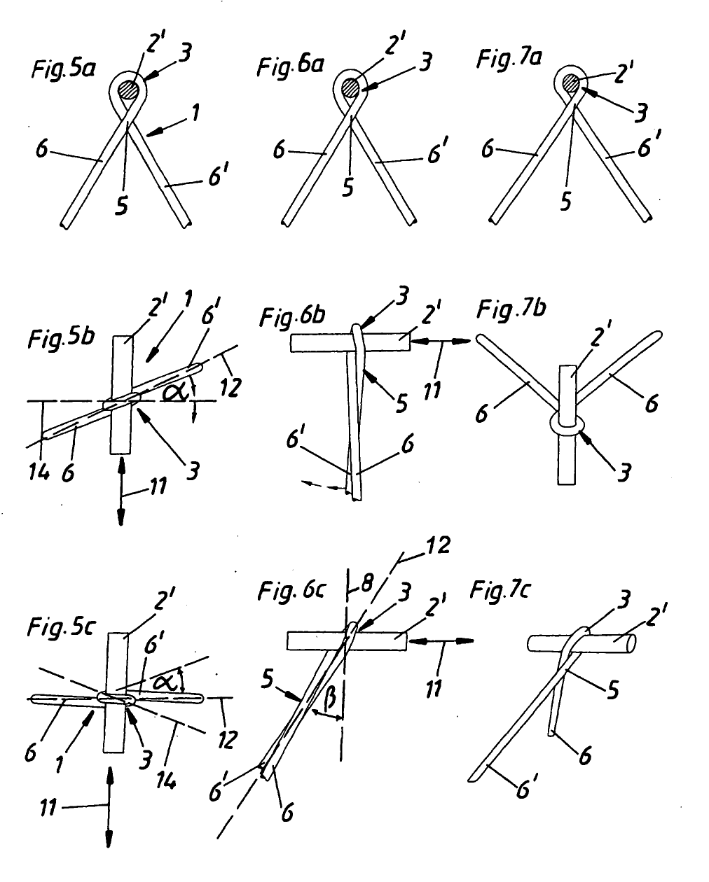

FIGS. 5a-5c show detail views to illustrate twisting of the loops with respect to the bars in a first direction,

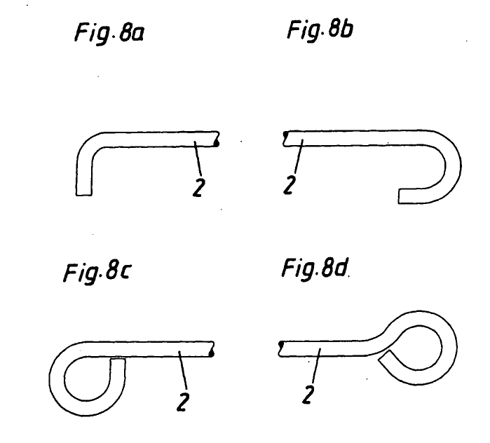

FIGS. 6a-6c show detail views to illustrate twisting of the loops with respect to the bars in a second direction,

FIGS. 7a-7c show detail views relating to superimpositioning of tilting and twisting in two directions,

FIGS. 8a-8d show detail views regarding possible end terminations of the bars,

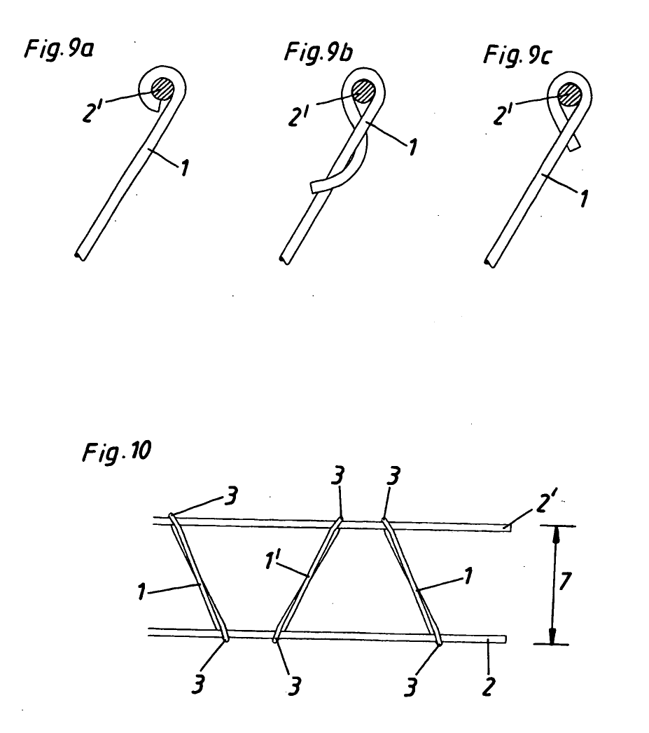

FIGS. 9a-9c show detail views regarding possible end terminations of the wires,

FIG. 10 shows a side view of a second embodiment,

FIGS. 11a, b show detail views of a third embodiment, and

FIGS. 12a, b show detail views of a fourth embodiment.

In the grid structures shown in FIGS. 1 through 10 the wire webs 1, 1′ embrace the bars 2, 2′ by means of the loops 3. The bars 2′ are arranged in an upper plane 4′. The lower bars 2 are arranged in a lower plane 4. The spacing 7 between the planes 4 and 4′ formed by the bars 2 and 2′ is a multiple, preferably at least ten times, of the maximum diameter of the bars 2, 2′. That provides a three-dimensional structure which ensures good stability and stabilisation, both as concrete reinforcement and also as a fastening or consolidation grid. Two adjacent limbs 6 and 6′ of the wire web I cross in the crossing regions 5 to produce the loops 3. In the crossing regions the two limbs 6 and 6′ bear against each other or are spaced from each other at only a very small distance. In that case the smallest spacing in the crossing region 5 is less than three times the thickness of the wire, preferably less than the thickness of the wire. That forms a substantially closed loop 3. Therein, the bars 2, 2′ are fastened by clamping in two different directions, as described in detail hereinafter with reference to FIGS. 5a-7c.

The wire webs 1, 1′ are of a substantially flat configuration in the sense that the height of the wire webs perpendicularly to their longitudinal extent 9 and perpendicularly to their transverse extent 10 is less than five times and preferably less than three times the wire thickness of the wire web 1, 1′. The positions of the planes formed by same are shown in the side view of FIG. 2 of the grid structure. The planes of the wire webs are afforded in a mathematically precise sense by the wire thickness notionally approximating towards zero. It can also be clearly seen from FIG. 2 that the loops of two wire webs 1, 1′ arranged in adjacent relationship on the bars 2, 2′ do not engage into each other. That is advantageous in particular in the sense of the grid structure being simple to manufacture. In spite of the adjacent loops not engaging into each other, sufficient strength for the grid structure is afforded solely by clamping of the bars 2, 2′ in the loops 3, possibly supported by adjacent loops 3 bearing against each other. As can be seen in particular from the top plan view of FIG. 1, the wire webs 1, 1′ are arranged exclusively in the direction in which their longitudinal extent 9 extends perpendicularly to the longitudinal extent 11 of the bars 2, 2′. There is therefore no need to provide additional wire webs 1, 1′ in the direction of the longitudinal extent II of the bars 2, 2′ or diagonally thereto or in other directions. The same also applies to the bars 2, 2′. In the illustrated embodiments these are also arranged exclusively in mutually parallel relationship. There are therefore preferably no bars 2, 2′ extending transversely with respect to the direction 11. The grid structure also attains the necessary strength in the illustrated orientation between the wire webs 1, 1′ and bars 2, 2′. That fact also simplifies manufacturability and stackability of the overall structure. The good stackability of grid panels according to the invention which are placed one upon the other both reduces the storage or transport volume and also increases storage and transport stability of the grid structure, which affords both a cost advantage and also a quality advantage.

In the illustrated embodiment the bars 2, 2′ are straight and are of a circular round configuration. That is preferably provided as there is no need for special shaping for the bars 2, 2′, which in turn makes the grid simpler to manufacture. In other configurations it is also possible for the bars 2, 2′, in compliance with the demands in respect of the overall structure, to be of a bent or curved configuration or for their cross-section to be of a configuration differing from the circular shape. Depending on the respective demands and purpose of use, it is possible to use bars 2, 2′ involving the same shaping and the same tensile strengths, in the various planes 4, 4′. It is however also possible to use various bars 2, 2′ of different material and/or involving different levels of tensile strength and/or of different diameters, in the various planes 4, 4′. That can be desirable in particular when using the grid structure as concrete reinforcement if the tensile loading in the two planes 4 and 4′ is of differing magnitude. For adaptation to the tensile loadings on the overall structure, besides those measures, it is however also possible to provide for adaptation of the spacings of adjacent bars 2 or 2′ in the respective planes 4, 4′. For high levels of tensile loading, it is possible for example to provide a smaller spacing of the bars 2 or 2′ in the planes 4, 4′, whereby then more bars are to be found along the longitudinal extent 9. That then results in a smaller angle β (see FIG. 2). For low levels of tensile loading, the spacing or the angle β can be selected to be correspondingly larger.

Moreover, particularly in the case of concrete construction, the freely accessible intermediate spaces 13 can be used to introduce there for example pipe or tube members, empty pipe or tube members or bodies of lower density. It is then possible to save weight in the central part of the overall structure, by virtue of the bodies of lower density, as no concrete is required there. If pipe or tube members or empty pipe or tube members are introduced into the free spaces 13, that is a simple elegant way of laying water or power or other supply lines in the concrete body.

In the illustrated embodiments of FIGS. 1 through 10 the wire webs 1, 1′ or the loops 3 thereof are clamped to the bars 2, 2′ by twisting or tilting in two different directions. FIGS. 5a-5c serve to illustrate clamping by twisting of the wire webs 1, 1′ with respect to the bars 2, 2′ in a first direction. Reference is made to FIGS. 6a-6c to show additional tilting of the wire webs 1, 1′ with respect to the bars 2, 2′ in a second direction. FIGS. 7a-7c show the end result.

FIG. 5b shows a top plan view of the grid structure illustrating firstly the position in which the bars 2′ can be substantially freely introduced into the loops 3. In this case the area of the inner opening of the loop 3 is selected to be so great that, when arranged substantially perpendicularly to the plane 14 of the opening of the loop 3, the bar 2, 2′ is substantially freely movable in the direction of its longitudinal extent 11 in the loop. The bar 2′ can be pushed into the loop 3 in that position. To achieve the clamping effect the wire web, illustrated by the limbs 6, 6′, is then turned in the direction of the arrows shown in FIG. 5b until it is arranged twisted, in the plan view shown in FIG. 5c, substantially perpendicularly to the longitudinal extent 11 of the bars 2, 2′. The bar 2′ is already very firmly held by clamping in the loop 3 by twisting in a first direction. To permit that, the plane 14 of the opening is arranged at an angle differing from 0° with respect to the longitudinal extent 9 of the wire web or with respect to the plane 12 of the wire web 1, 1′. The angle between the opening plane 14 and the plane 12 of the wire web is predetermined in the illustrated embodiment by the size of the area of the inner opening of the loop 3, the wire thickness and the spacing of the limbs 6, 6′ in the crossing region 5. In order already to achieve sufficiently firm clamping in that position, a rotary angle α of between 20° and 30° is desirable. In the illustrated embodiment α is about 25°. The angle between the two planes 12 and 14 desirably corresponds to the necessary twist angle α. FIG. 5a is a side view corresponding to FIG. 3 showing the position between the bar 2′ and the wire web 1 before commencement of the twisting operation, that is to say in the position shown in plan view in FIG. 5b.

In addition to the twisting as shown in FIGS. 5a through 5c the wire webs 1, 1′ in the illustrated embodiment are also arranged tilted in a side view of the grid structure with respect to a longitudinal extent 11 of the wire webs 1, 1′ at an angle β differing from the perpendicular 8. FIG. 6b shows a side view illustrating the condition prior to tilting in the direction of the arrows shown in this Figure. FIG. 6c shows the condition after tilting. The tilt angle β is desirably between 20 and 40°, in the illustrated embodiment being about 30°. The side view of FIG. 6c is a detail view from FIG. 2 in which the tilt angle β is also shown. In manufacture of the grid structure the bars 2, 2′are firstly pushed into the loops 3 in the position shown in FIG. 5b. Twisting into the position shown in FIG. 5c then occurs, that is to say twisting in a first direction. In a further working step, twisting is then effected in a second direction through the angle β, resulting in the position shown in FIG. 6c. FIGS. 7a, 7b and 7c show detail views relating to the end result of that twisting and tilting. Even if clamping of the bars 2, 2′ in the loops 3 of the wire web 1, 1′ is desirably effected by both twisting and tilting operations, it is nonetheless possible for the fastening effect to be afforded only by twisting or only by tilting. In addition it is clear that, in regard to twisting and/or tilting, the relative movement between the wire webs 1, 1′ and bars 2, 2′ is the only important consideration. It is therefore immaterial whether the bars 2, 2′ are twisted and/or tilted with respect to the wire webs 1, 1′, or vice-versa.

The wire thicknesses are generally less than the smallest diameter of the bars 2, 2′. To afford a clamping action which is as firm as possible, it is desirable if the wire thickness is at most half the smallest diameter of the bars 2, 2′.

The wires of the wire webs 1, 1′ desirably have steel involving wire thicknesses of between 1.6 mm and 2.8 mm or consist of such a steel. Depending on the respective task involved in that respect tensile strengths for the material used are generally to be selected at between 400 and 600 N/mm². The bars 2, 2′ generally involve higher levels of tensile strength than the wires—mostly in the range of between 400 and 2500 N/mm². The bars 2, 2′ can however not only consist of or have corresponding steels but for example also plastic materials which preferably involve high tensile strength and/or are fiber reinforced. In this case also attention is to be directed to suitable tensile strength values.

If steel is adopted as the material for the bars 2, 2′ or the wires of the wire webs 1, 1′, a coating, preferably comprising one or more zinc or zinc alloy layers, can be provided for corrosion protection. In that respect, it is desirable in a grid structure according to the invention that the coating initially applied to the bars 2, 2 and the wires of the wire web 1, 1′ is not destroyed or adversely affected by manufacture of the structure. Instead of a coating it will be appreciated that it is also possible to select a stainless steel of suitable nature for corrosion protection. In selecting the material and the coating the person skilled in the art can have recourse to existing standards. They would be EN 10080 for reinforcing concrete. It is also possible to switch to materials which are known in accordance with EN 10223 for the production of fences. The person skilled in the art also finds suitable material specifications in EN 10264 which is primarily concerned with the manufacture of cables. It is also possible to refer to EN 10337 for tensioning steel wires and EN 15630-1 for reinforcing and prestressing concrete. If necessary attention is to be directed to EN 10244 in regard to coatings for corrosion protection. Suitable stainless steels are to be found in EN 10088. The choice of the material and also the question of whether the upper bars 2′ and the lower bars 2 are or are not made from the same material with the same tensile strengths is always to be matched to the corresponding requirements to ensure optimum adaptation to the purpose of use.

FIGS. 8a through 8d show various embodiments in which the ends of the wire webs 2, 2′ can be bent. It is however not absolutely necessary for the ends to be bent round. A hook-shaped configuration for the ends of the bars 2, 2′ as shown in FIGS. 8a and 8b can be provided for such a hook to hookingly engage into adjacent panels of the structure or the like. The provision of ring-like terminations as shown in FIGS. 8c and 8d can be involved if, to save material, the intention is to dispense with an overlap of two adjacent grid structures. By virtue of the rings it is possible to connect two panels or grid structures to a fitment bar which is inserted into the rings. If material saving is not necessarily a foreground issue, the connection between two panels or grid structures can also be easily applied by laying two adjacent panels one into the other. For that purpose it is particularly advantageous if—as shown in FIGS. 1, 3 and 4—the grid structure ends on one side of the longitudinal extent 9 of the wire webs 1 with a lower bar 2a and on the other side with an upper bar 2b′. With this structure, for connecting the individual panels, it is sufficient for them to be simply laid one in the other. FIGS. 9a through 9c show various variants of the way in which the ends of the wires of the wire webs 1, 1′ can be designed.

For structural heights in respect of the grid structure, that is to say spacings between the planes 4 and 4′ or the centers of the bars 2, 2′ of 45 mm, 75 mm or 100 mm, tensile bars of steel of a diameter of 3.0 mm are desirably to be adopted. With structural heights of 125 mm a bar diameter of 4.0 mm is generally desirable while with structural heights of 150 mm a bar diameter of 5.0 mm is generally desirable. The length of the grid structure or panels, that is to say the extent thereof in the direction 11, is basically to be adapted to the needs and the transport options. In earthwork engineering in which the grid structure is used as a ground consolidation grid, panel lengths of about 3 m are frequently preferred. When used as concrete reinforcement the grid lengths can be adapted to present day standard structural lengths. These are for example 3, 4, 5, 6, 8 and 12.50 m. Nonetheless the structure according to the invention can be manufactured in any lengths and sizes. Cutting to size on site at the building location to give the appropriate lengths and widths is also possible at any time.

FIG. 10 shows a side view similar to FIG. 2, showing that the loops 3 do not have to be arranged in immediately adjacent relationship or bearing against each other on the bars 2, 2′. As shown in FIG. 10 it is also possible to adopt a larger spacing between each two adjacent wire webs 1, 1′ along the longitudinal extent 11 of the bars 2, 2′, which leads to a saving in material and weight.

The first embodiment of FIGS. 1 through 4 however has the advantage that the loops 3 of adjacent wire webs 1 and 1′ can also be supported against each other when a high loading is involved in addition to the clamping effect.

In the embodiments shown in FIGS. 1 through 10 the loops 3 are of a substantially closed configuration by each two limbs 6, 6′ of the wires crossing in a crossing region 5 to form one of the loops, wherein the smallest spacing of the limbs 6, 6′ of the wires relative to each other in the crossing region 5 is less than three times the wire thickness, in particular less than the wire thickness. That however is not the only possible way of producing substantially closed loops.

FIGS. 11a and 11b show detail views similar to FIGS. 7b and 7c, illustrating a variant in which the wire is wound through more than 360° about the notional center of the loop 3, to form the loop 3. That affords a spiral-shaped arrangement of the wire in the region of the loop 3. In addition, in the illustrated embodiment of FIGS. 11a and 11b, the criterion is additionally also satisfied, that the limbs 6 and 6′ are not further away from each other in the crossing region 5, than three times the wire thickness. However, that does not necessarily have to be provided as the loop 3 is already substantially closed by the spiral arrangement of the wire. The wires desirably again bear against each other in the region of the loop 3. In this embodiment also the bar 2 or 2′ can be twisted and tilted in two directions for clamping in the loop, similarly as is illustrated in FIGS. 5a through 6c for the first embodiment. Particularly in relation to the spiral configuration of the loop however it is frequently already sufficient for the bars 2, 2′ to be either only tilted or only twisted in the loops 3.

The fourth embodiment shown in FIGS. 12a and 12b differs in that the limbs 6 and 6′ do not cross. They are wound through more than 360° in the running direction. That improves stackability.

Except for the specified difference in the configuration of the substantially closed loop the third and fourth embodiments can be designed in a similar fashion to the two previously illustrated embodiments so that there is no need for representations relating to the overall grid structure and description relating to further details, with reference being directed to the foregoing description relating to the other embodiments.

Overall, a grid structure which is simple to manufacture but which is highly stable in terms of its structural configuration is provided. There is no need for pressing or other additional connection of the wire webs 1, 1′, which extend in the load-bearing direction, to the bars 2, 2′, as the connection which is based on clamping is sufficiently stable without that. That additionally provides for a marked reduction in the cost of manufacture of the grid structure. When using the grid structure as a ground consolidation grid, particularly good fixing of the filling material is achieved as the structure provides for tight wire web diagonal stressing between the upper and lower bars 2, 2′.

1-47. (canceled)

48. A grid structure comprising:
a plurality of mutually juxtaposed wire webs formed from wires bent in a zigzag shape;
a plurality of bars, said wires of said wire webs embrace said bars in the form of substantially closed loops;
wherein for fastening to said wire webs, said bars are clamped in said loops of said wire webs, said bars for clamping in said loops of said wire webs being arranged twisted or tilted relative to an opening plane of said loops.

49. The grid structure according to claim 1, wherein said grid structure is a reinforcement grid or a ground consolidation grid.

50. The grid structure according to claim 1, wherein said bars extend in mutually parallel relationship.

51. The grid structure according to claim 1, wherein fastening of said bars in said loops of said wire webs is based exclusively on clamping.

52. The grid structure according to claim 4, wherein fastening of said bars can additionally achieved with additional contact of two adjacent loops abutting against each other.

53. The grid structure according to claim 1, wherein said bars for clamping in said loops (3) of said wire webs (1, 1′) are arranged twisted or tilted at least in two directions with respect to said loops.

54. The grid structure according to claim 1, wherein for clamping said bars in said loops, said wire webs are arranged twisted in a plan view onto the grid structure relative to a longitudinal extent of said bars.

55. The grid structure according to claim 7, wherein said wire webs are arranged twisted in a plan view onto the grid structure in a substantially perpendicular direction to a longitudinal extent of said bars.

56. The grid structure according to claim 1, wherein for clamping said bars in the loops, said wire webs are additionally arranged tilted in a side view of the grid structure with respect to said bars at an angle (b) differing from the perpendicular.

57. The grid structure according to claim 1, wherein an area of an inner opening of said loop is so large that said bar is substantially freely movable in an direction of a longitudinal extent of said bar when said bar is arranged substantially perpendicularly to a plane of said opening of said loop.

58. The grid structure according to claim 10, wherein a plane of said opening of said loop is arranged at an angle differing from 0° with respect to a longitudinal extent of said wire web.

59. The grid structure according to claim 1, wherein a wire thickness is less than a smallest diameter of said bars or being at most half the smallest diameter of said bars.

60. The grid structure according to claim 1, wherein the loops of two wire webs arranged adjacently on said bars do not engage into each other.

61. The grid structure according to claim 1, wherein said wire webs are substantially flat in the sense that a height of said wire webs perpendicularly to their longitudinal extent and perpendicularly to their transverse extent is less than five times or less than three times the wire thickness of said wire web.

62. The grid structure according to claim 1, wherein said bars are arranged in at least two mutually spaced planes.

63. The grid structure according to claim 15, wherein a spacing of said planes formed by said bars from each other is a multiple or at least ten times the maximum diameter of said bars.

64. The grid structure according to claim 15, wherein said bars of said at least two mutually spaced planes are of different tensile strengths.

65. The grid structure according to claim 15, wherein two adjacent loops of said wire web embrace bars from different planes.

66. The grid structure according to claim 1, wherein the wires of said wire webs comprise steel with a tensile strength of between at least 400 and 600 N/mm² or consist of such a steel.

67. The grid structure according to claim 1, wherein said bars have or consist of at least one plastic material which is of high tensile strength or fiber reinforced.

68. The grid structure according to claim 1, wherein said bars have or consist of a steel with a tensile strength of between at least 400 and 2500 N/mm².

69. The grid structure according to claim 1, wherein at least one of said bars and said wires of said wire webs have a coating for corrosion protection.

70. The grid structure of claim 22, wherein said coating comprises zinc or a zinc alloy or comprises stainless steels.

71. The grid structure according to claim 1, wherein the wires comprise each comprise two limbs, said two limbs cross in a crossing region to produce one of said loops, wherein a smallest spacing of said limbs of said wires relative to each other in the crossing region is less than three times the wire thickness or less than the wire thickness.

72. The grid structure according to claim 1, wherein a wire of said wire web is wound through more than 360° around a center of said loop to produce a substantially closed loop.

73. The grid structure according to claim 25, wherein limbs adjoining said loops do not cross.
